(19) United States
(12) Patent Application Publication
(10) Pub. No.: US 2009/0308481 A1
(43) Pub. Date: Dec. 17, 2009

(54) Cu/Al COMPOSITE PIPE AND A MANUFACTURING METHOD THEREOF

(75) Inventors: Kejian Xiao, Jiangsu Province (CN); Wei QI, Jiangsu Province (CN); Fusheng Tian, Jiangsu Province (CN)

Correspondence Address: WOOD, HERRON & EVANS, LLP, 2700 CAREW TOWER, 441 VINE STREET, CINCINNATI, OH, 45202, US

(73) Assignee: Jiangsu Xingrong Hi-Tech Company Limited, Changzhou , Jiangsu (CN)

(21) Appl. No.: 12/297,033

(22) PCT Filed: Aug. 29, 2006
(86) PCT No.: PCT/CN2006/002218

§ 371 Date: Mar. 24, 2009

(30) Foreign Application Priority Data
Apr. 24, 2006 (CN) 200610076037.8

(51) Int. Cl. B21B 37/78; F16L 9/14; B21B 13/20; B21B 37/74

(52) U.S. Cl. 138/142; 138/143; 72/364; 72/368; 72/201

(57) ABSTRACT

A Cu/Al composite pipe and a manufacturing method thereof are disclosed. The inner layer of the pipe is Cu, and the outer layer is Al. The combinative layer is formed between the two layers due to mutual diffusion of Cu and Al. The raw composite pipe is rolled with single rolling by a planetary rolling machine, wherein the rolling process has the single pass percentage reduction of area of 50%˜95%, an exit rolling speed of 5˜30 m/min, a temperature in the deformation area of 200° C. ˜600° C. The pipe can be used in many fields, such as architecture, refrigeration, air-conditioners, refrigerators, solar energy, water heaters, condensers and radiators, etc.

### TECHNICAL FIELD OF THE INVENTION

The present invention relates to a metal composite pipe and a manufacturing method thereof, more particularly to a Cu/Al composite pipe and a manufacturing method thereof.

### PRIOR ART

Due to the excellent corrosion resistance, heat conductivity and mechanical property of Cu and its alloys, Cu and Cu alloy pipes are usually used as transmitting pipes for liquid in many fields and products, such as architecture, cooling, air conditioning, refrigerators, solar energy, water heaters, condensers and radiators. However, Cu is not an abundant resource and is very expensive. Furthermore, Cu has a large specific gravity such that pipes composed of Cu are heavy. Therefore, a substitute for the pipe material of Cu and Cu alloys is needed. Al and Al alloys are one potential substitute, because those materials have many advantages: Al is less costly than Cu due to its abundance (such as half of Cu's price) and is light weight (only ⅓ of Cu's specific gravity). Al also has obvious weaknesses compared with Cu. For instance, the strength, corrosion resistance, heat conductivity and mechanical properties of Al are inferior to those of Cu. Hence, pipes of pure Al are not good substitutes for Cu pipes in many situations. For example, an Al pipe is not capable of being a heat exchange pipe for an air conditioner or a refrigerator. Such pipes demand a long service life, usually in excess of 10 years. Leakage can develop in Al heat exchange pipes used the evaporator and the condenser of air conditioners and refrigerators after only 1-2 years. The problem is especially acute for air conditioners. They tend to be operated only in summer and winter, so as to have long period of shutdown which can more readily lead to fatal corrosion leaks of the evaporator and condenser heat exchange pipes made of Al.

Although Cu has a high corrosion resistance and heat absorption coefficient, the heat release coefficient of Cu is lower than that of Al. Therefore, in the refrigeration/heating fields, such as air conditioners and refrigerators where a high heat release coefficient is demanded, it is common to use Cu pipe as the heat exchange pipe, and to dispose Al cooling fins on the outside thereof, so as to increase the heat exchange rate. But that practice presents the problem of electrochemical corrosion between the Al cooling fins and Cu pipe after long term usage. Such corrosion can block heat exchange and reduce the heat exchange coefficient. This problem has been known, and some solutions have been provided. Chinese patent application CN1474155 (App No: CN02129108.X) discloses use of a layer of insulation material disposed on the outside of a heat exchange pipe of a condenser. Although that solution solves the problem of electrochemical corrosion by causing the Cu pipe and Al cooling fins to be only indirectly contacted, the heat efficiency of the condenser is weakened, and the thermal conductivity coefficient from the Cu pipe to Al cooling fins is reduced.

Hence, experts in the field have studied Cu/Al composite pipe to obtain the advantages of Cu and Al.

In order to best obtain the advantages of Cu and Al, three forms of the Cu/Al composite pipe are studied: i) the Al pipe inserted between inside and outside Cu pipe layers; ii) the Al pipe outside and Cu pipe layer inside; iii) the Al pipe inside and the Cu layer outside. Generally, a Cu/Al composite pipe in which the Cu pipe is inserted between inside and outside Al pipes is not used because its performance is the same as that of a pipe formed of pure Al or its alloys and so does not overcome the defects of the Al pipe, is expensive and presents processing difficulties. Generally, Cu and Cu alloys are used as the inner layer of the composite pipe that contacting the transmitted liquid so as to take advantage of the superior corrosion resistance of Cu and Cu alloys. On the other hand, Al or Al alloys are disposed as the outer layer of the composite pipe as the supporting body, so as to ensure the strength and stiffness of the pipe. This type of Cu/Al composite pipe is lighter and costs less than a pipe of pure Cu or its alloys, so that it can be a substitute for Cu and Cu alloy pipes in many situations. However, before the present invention, people have been seeking an improved method for manufacturing a Cu/Al composite pipe with superior mechanical properties and quality. The products of the prior art have insufficient mechanical properties and quality, so that defects arise during further processes, such as separation, peeling and folding, etc. Therefore, the past attempts to replace Cu and Cu alloy pipes with Cu/Al composite pipes have failed.

The known methods of manufacturing Cu/Al composite pipes mainly are cast rolling, drawing and extruding, etc. These methods assemble the raw Cu and Al pipes surface treated together to form a pipe blank, then process the pipe blank with rolling, drawing, extruding, or a combination thereof, and process with repeated anneal and/or combined rolling, drawing and extruding steps, to finally prepare the Cu/Al composite pipe. However, the products of these methods exhibit an undesirable level of mechanical bonding and so the combinative surfaces may separate, peel and fold in further processes and applications, which can lead to fatal electrochemical corrosion when immersed into an electrolyte solution. Such problems are an important reason why conventional Cu/Al composite pipes cannot replace pure Cu and Cu alloy pipes.

### SUMMARY OF THE INVENTION

The present invention is directed to solving the problems existing in the prior art, and accordingly, provides a method for manufacturing Cu/Al composite pipe with reduced manufacturing processes, higher production efficiency, and lower cost.

Another object of the present invention is to provide a Cu/Al composite pipe having high quality and improved mechanical properties so as to satisfy requirements of further processes and applications.

A further object of the present invention is the use of the Cu/Al composite pipe.

According to the present invention, a method is provided for manufacturing a Cu/Al composite pipe, in that a Cu/Al composite pipe blank is rolled with a single pass rolling by a planetary rolling machine, wherein a single pass percentage reduction of area is 50%˜95%, an exit rolling speed is 5˜30 m/min, and a temperature in a deformation area is 200° C.˜600° C.

The Cu/Al composite pipe is cooled to an ambient temperature after the rolling process.

The processes of the single pass rolling and the rapid cooling are operated under a protective atmosphere.

The Cu/Al composite pipe, after cooling to the ambient temperature, is processed to a desired Cu/Al composite pipe by directly drawing without anneal, or the desired Cu/Al composite pipe is further processed to form a Cu/Al composite pipe with an internal thread by a high speed spinning process.

The planetary rolling machine has 3 to 6 rollers.

The Cu/Al composite pipe blank is obtained by a process of continuous casting.

The Cu/Al composite pipe blank is obtained by a surface treatment for combinative surfaces of a Cu pipe blank and a Al pipe blank, and then by a physical bonding treatment.

The Cu/Al composite pipe blank is obtained by a surface treatment for combinative surfaces of a Cu pipe blank and a Al pipe blank, and then by a pipe expanding treatment.

Cu means Cu and its alloys; Al means Al and its alloys.

A Cu/Al composite pipe manufactured by the method of the present invention, is characterized by an inner Cu layer, an outer Al layer, and a combinative layer formed in a combination portion of the Cu layer and the Al layer due to a mutual diffusion of Cu layer and Al layer. The combinative layer achieves a metallurgical bonding of the inner Cu layer and the outer Al layer.

A thickness ratio of the Cu layer and the Al layer is 1:0.4˜20.

A thickness of the combinative layer is 1˜3 μm.

An outer surface of the Al layer is coated or plated with an anticorrosion layer.

The Cu layer is a layer of Cu or its alloys and the Al layer is a layer of Al or its alloys.

The Cu/Al composite pipe is adapted to be used in products of air-conditioning, refrigerators, solar energy, water heaters, condensers, and radiators.

The method for manufacturing the Cu/Al composite pipe according to the present invention has advantages compared with those traditional methods:

1. The manufacturing method of the present invention can achieve a metallurgical bond of the Cu/Al composite surface.

In accordance with the present invention, the Cu/Al composite pipe blank is rolled with a single pass rolling by a planetary rolling machine with a single pass percentage reduction of area of 50%˜95% and an exit rolling speed of 5˜30 m/min, a high instant deformation heat is produced such that a temperature of the rolled pipe material in the deformation area is dramatically increased to 200° C.˜600° C. Under these rolling conditions, sufficient heat is generated in a Cu/Al combinative surfaces of the deformation area so that a dynamic restored recrystallization occurs and the atoms of Cu and Al are mutually diffused or penetrated in the deformation area. Hence, a metallurgical bonding of the Cu and Al layers results. Furthermore, the planetary rolling machine can continuously process the Cu/Al composite pipe blank with high deformation speed and a large deformation amount. Because the pipe blank to be rolled continuously enters into the planetary rolling machine, a continuously-dynamic restored recrystallization is produced in the Cu/Al combinative surfaces of the deformation area so as to achieve the metallurgical bonding. Consequently, the entirety of the combinative surfaces of the Cu/Al composite pipe material achieves metallurgical bonding, which is not achieved by any prior processing method.

2. The manufacturing method of the present invention can manufacture the Cu/Al composite pipe with less processing, higher efficiency, mass order, and lower cost.

In conventional methods, the length and weight of the composite pipe are restricted due to the numbers of processes and the non-continuous processing such that longer and heavier weight composite pipes cannot be produced. The present invention dramatically simplifies the processes and increases the efficiency because the composite pipe is rolled with a single pass rolling by a planetary rolling machine. The planetary rolling machine is a professional rolling mill, usually has 3 rollers, 4 rollers or 5 rollers, and can continuously process the Cu/Al composite pipe blank with high deformation speed and a large deformation amount. Hence, the method of the present invention can process pipe blanks with longer length, thicker thickness and heavier weight, such as a pipe blank with an outer diameter by wall thickness by the length of φ90 mm×25 mm×22,000 mm and a weight of over 400 kg, which conventional methods cannot process. Continuous rolling of a heavy pipe blank at a high processing speed is suitable for a mass industrial production, so that the manufacturing cost of the Cu/Al composite pipe is markedly reduced.

Cu/Al composite pipes prepared according to the methods of the present invention also have advantages compared with traditional Cu/Al composite pipes:

1. The Cu/Al composite pipe prepared according to the method of the present invention has better mechanical properties and satisfies the requirements of further processes.

The method of the present invention causes the combinative surfaces of the rolled Cu/Al composite pipe to have sufficient heat so as to continuously produce dynamic restored recrystallization, i.e., to metallurgically bond the combinative surfaces. These Cu/Al composite pipes with a structure produced by the continuously dynamic restored recrystallization have excellent mechanical properties, and in ensuing processes, the pipe can be drawn to a desired standard directly and dimensioned without anneal. In addition, this metallurgical bonding of the combinative surfaces also ensures that there is no separation and peeling of the Cu/Al surfaces. Also, during the processes that bond and extend the pipe, the defects of peeling and folding etc. do not occur. However, Cu/Al composite pipes prepared by the conventional methods do not have these excellent mechanical properties and excellent properties when further processed.

2. Cu/Al composite pipes prepared according to the method of the present invention have extraordinary heat exchange efficiency.

Cu and Cu alloys have greater transient heat absorption than Al and Al alloys, whereas Cu and Cu alloys have a lower rate of heat radiation than Al and Al alloys. The present invention combines these respective advantages of Cu and Al, namely to contact the thermal transfer medium with the Cu inner layer so as to absorb heat and to radiate heat with the Al outer layer, while the metallurgical bonding of the Cu/Al combinative surfaces, eliminates the heat resistance between the two different materials. Consequently Cu/Al composite pipes of the present invention have excellent heat transfer effects, and are the best choice for the pipes of a radiator and a heat exchanger.

3. The Cu/Al composite pipe prepared according to the method of the present invention can be used in many devices as an accessory, and also dramatically reduces the manufacturing costs of these devices.

Because of the metallurgical bonding of the Cu/Al combinative surfaces, the Cu/Al composite pipe of the present invention overcomes the deficiencies of the prior art and retains the virtues of Cu and Al, so as to replace pure Cu pipe used widely in fields of architecture, refrigeration, air conditioners, refrigerators, solar energy, water heaters, condensers and radiators, etc. On the other hand, the use of Cu/Al composite pipes can dramatically reduce the amount of Cu used, so as to reduce the material cost while providing an equal standard of quality.

### BRIEF DESCRIPTION OF THE DRAWINGS

These and other aspects and advantages of the invention will become apparent and more readily appreciated from the following descriptions taken in conjunction with the drawings in which:

FIG. 1 is a schematic cross-sectional view of a Cu/Al composite pipe of the present invention;

FIG. 2 is a schematic view of an embodiment, wherein the Cu/Al composite pipe of the present invention is used in a heat exchanger; and

FIG. 3 is an enlarged view of the portion C of FIG. 2;

wherein the Cu/Al composite pipe of the present invention is marked as 1, the inner layer of Cu and its alloys is marked as 2, the outer layer of Al and its alloys is marked as 3, the combinative layer achieved by Cu/Al metallurgy bonding is marked as 4, the condenser is marked as 5, the evaporator is marked as 6, the heat exchanger is marked as 7, the Al layer is marked as 51, and the Cu layer is marked as 52.

### DETAILED DESCRIPTION OF EMBODIMENTS OF THE INVENTION

Reference will be made in detail to embodiments of the present invention. The embodiments described herein with reference to drawings are explanatory, illustrative, and used to generally understand the present invention. The embodiments shall not be construed to limit the present invention. The same elements are denoted by like reference numerals throughout the description.

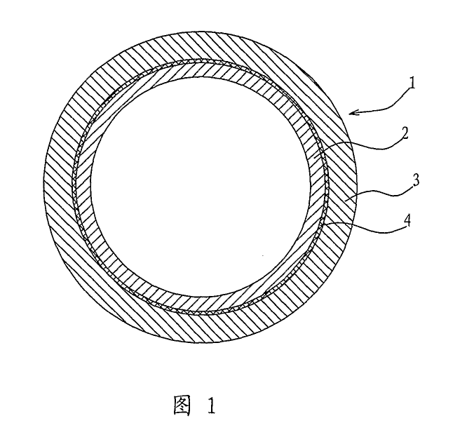

One preferred embodiment of the present invention is to roll a clad or composite pipe of oxygen free copper (T2 Cu) and pure Al (1060 Al) with the Cu portion of the pipe blank disposed as the inner layer. The rolling machine is a 3-roller planetary rolling machine XR-SG90, which can be commercially purchased. The Cu and Al pipe blanks are respectively prepared by a horizontal continuous casting method. The specification of pipe blanks is φ83×20.5 mm, wherein the thickness of the Cu layer is 2.5 mm, the thickness of the Al layer is 18 mm, the pipe blank length is 20 m, and the pipe blank weight is 260 kg. The pipe blank is rolled with a single pass rolling using the 3-roller planetary rolling machine. A rolling speed in an exit of the pipe blank is controlled at 15 m/min, a temperature in a deformation area of the pipe is increased to 450° C., a size of the pipe blank in the exit is φ47×2.5 mm, and a single pass percentage reduction of area is 91%. These specifications are obtained by regulating a rotating speed, a flow rate of a cooling liquid, a feed rate of the pipe blank, etc. of the 3-roller planetary rolling machine. Subsequently, the rolled pipe is placed into an emulsion bath having a length of 1.5 m to quickly cool the pipe to ambient temperature, and then the pipe is bended to a roll and enters into a material tank. Because the entirety of the rolling and cooling processes are performed under conditions of a protective atmosphere, there are no fold lines, folds, or other defects formed on the outer surface of the Cu/Al composite pipe and the combinative surfaces of the prepared Cu/Al composite pipe completely achieve metallurgical bonding. As shown in the FIG. 1, the inner layer 2 of the Cu/Al composite pipe 1 prepared according to the above mentioned method is the Cu layer, the outer layer 3 thereof is the Al layer, and the combinative layer 4, which supplies the metallurgical bonding of the Cu layer 2 and the Al layer 3, is formed between the Cu layer 2 and the Al layer 3 due to mutual atomic diffusion of Cu and Al atoms. The thickness of the combinative layer 4 is 2 μm. A thickness ratio of the Cu and Al layers of the prepared Cu/Al composite pipe 1 is 1:7.2. A tensile strength and an elongation rate of the Cu/Al composite pipe, respectively, are 70 MPa˜80 MPa and 35%˜45%. The Cu/Al composite pipe can be drawn to a size of φ12.7×0.75, in particular a size of φ6.35×0.7, by a coil-drawing method and without anneal. Hence, the drawn composite pipe is adapted to be a connecting pipe between outer and inner portions of an air conditioner. Moreover, the above mentioned Cu/Al composite pipe 1 may be coated or plated with an anti-corrosion layer by electroplating on the outer surface in order to prevent the formation of corrosion on the Al layer by electrolysis while used as a connecting pipe between the inner and outer portions of the air conditioner.

In addition, the above mentioned Cu/Al composite pipe also can be processed to an internally threaded pipe having an outer diameter of φ9.52, in particular of φ7, wherein the threads thereof are various, such as oblique threads, high-low threads and cross threads, etc.

The second preferred embodiment of the present invention is to roll the bonded composite pipe of a Cu pipe blank (TP2 Cu) and a Al pipe blank (3003 Al) which respectively are manufactured by the horizontal continuous casting method, wherein the Cu pipe blank is disposed as the inner layer. The rolling machine is also the 3-roller planetary rolling machine XR-SG90. The initial dimension of the Al pipe blank is φ50×12 mm. The inner surface of the Al pipe blank is degreased and polished by a steel wire brush to make the inner surface thereof bright and oxidation-free. The Cu pipe blank, which has a size of φ25×2.2 mm, is placed inside of the Al pipe, after the outer surface of the Cu pipe blank is degreased and polished. The composite pipe blank is then introduced into the 3-roller planetary rolling machine XR-SG90. Subsequent processes will follow the corresponding processes of the first embodiment, except that the temperature of the deformation area of the pipe is 300° C., the rolling speed in the exit is 9 m/min, the single pass percentage reduction of area is 89.9%, and the size of the rolled composite pipe is φ27×2 mm. Folds (fold lines) and separation are not observed on the surface and the body of the composite pipe. The tensile strength and an elongation percentage thereof, respectively, are 110 MPa 130 MPa and 30%˜40%. The thickness ratio of the Cu and Al layers of the composite pipe of this embodiment is 1:5.45. As observed with testing, the metallic phase structure of this Cu/Al composite pipe body is very dense and the combinative surfaces are metallurgical bonded, which reflects successful rolling. The composite pipe has sufficient mechanical properties for additional processes of coil drawing or straight drawing, so as to process to a desired composite pipe.

The third preferred embodiment of the present invention is to roll the bonded composite pipe of a Cu pipe blank (T2 Cu) and a Al pipe blank (3003 Al), which respectively are manufactured by a extruding method, wherein the Cu pipe blank is disposed as the inner layer. The rolling machine is also the known 3-roller planetary rolling machine XR-SG120. The initial dimension of the Al pipe blank is φ110×10 mm. The inner surface thereof is degreased and polished by a steel wire brush, so as to make the inner surface thereof bright and oxidation-free. A Cu pipe blank with a size of φ86×20 mm is placed inside of the Al pipe blank, after the outer surface of the Cu pipe blank is degreased and polished, A composite pipe blank with a size of φ110×(10+20) mm is formed by a method of pipe expansion. Next the composite pipe blank is introduced into the 3-roller planetary rolling machine XR-SG120. Subsequent processes will follow the corresponding processes of the first embodiment, except that the temperature of the deformation area of the pipe is 530° C., the rolling speed in the exit is 12 m/min, the single pass percentage reduction of area is 92.9%, and the size of the rolled composite pipe is φ60×3 mm. No folds or separation is observed on the surface and the body of the composite pipe. The tensile strength and elongation percentage thereof are, respectively, 110 MPa˜130 MPa and 30%˜40%. With a testing method, the metallic phase structure of this Cu/Al composite pipe body is very dense and the combinative surfaces are metallurgical bonded, which indicates the success of the rolling. The composite pipe has sufficient mechanical properties for additional processes of coil drawing or straight drawing, so as to process to a composite pipe for heaters. In practice, Al fins can be welded on the outer surface in order to increase the heat exchange area. If a pure Cu pipe is used, the welding process is configured to not cause heat resistance between Cu and Al. Hence, the thickness ratio of the Cu layer and Al layer of this Cu/Al composite pipe in the cross-section thereof is 1:0.5.

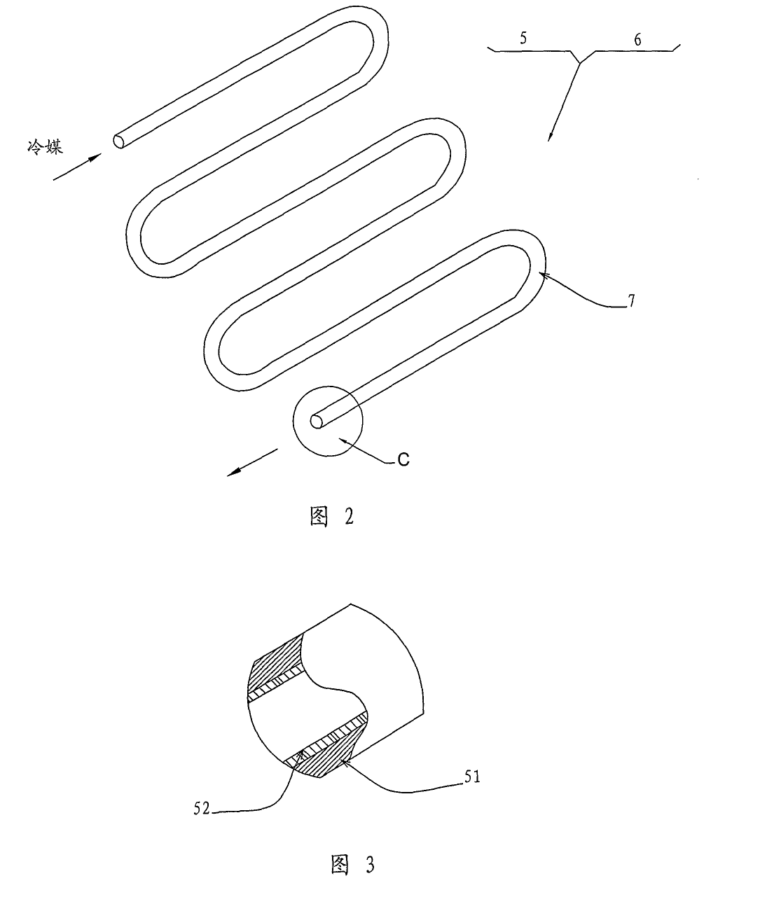

As shown is the FIG. 2, a schematic drawing illustrates an embodiment wherein a Cu/Al composite pipe is used in a refrigerator as a heat exchange device, namely a condenser. This condenser is formed by being the Cu/Al composite pipe of the present invention into a coil pipe. Every axis of the straight portions of the coil pipe are mutually parallel. This condenser is coupled to a compressor and an evaporator, etc., so as to form a heat exchange device of the refrigerator. When the cooling medium from the compressor, which is at high temperature and pressure, pass through the heat exchange pipe, the heat thereof is quickly transmitted and radiated, so as to cool the cooling medium. In order to increase the heat exchange rate of this condenser, the outer surface of the heat exchange pipe may be formed in various shapes, such as thread, wave and zigzag, or the inner surface thereof may be formed these shapes as well.

In summary of the above, the method for manufacturing Cu/Al composite pipe of the present invention has the advantages of reduced processing, a high extent of automation, a high rolling speed, a high rate of yield production, low manufacturing cost, and high quality of production. The present invention overcomes defects of the prior art and has recognizable progresses and essential characteristics. The Cu/Al composite pipe according to the manufacturing method has excellent mechanical properties and heat-conduction ability, and can replace conventional Cu and Cu alloy pipes in many fields with a dramatically reduced manufacturing cost.

Although explanatory embodiments have been shown and described, it would be appreciated by those skilled in the art that changes, alternatives, and modifications can be made in the embodiments without departing from spirit and principles of the invention. Such changes, alternatives, and modifications all fall into the scope of the claims and their equivalents.

1. A method for manufacturing a Cu/Al composite pipe, the method comprising rolling a Cu/Al composite pipe blank with a single pass rolling by a planetary rolling machine with a single pass reduction area rate ranging from 50% to 95% and an exit rolling speed ranging from 5 m/min to 30 m/min such that a temperature in a deformation area ranges from 200° C. to 600° C.

2. The method of claim 1, further comprising cooling said Cu/Al composite pipe to an ambient temperature after rolling.

3. The method claim 1, further comprising placing said Cu/Al composite pipe blank under a protective atmosphere during rolling.

4. The method claim 1, further comprising after rolling, directly drawing said Cu/Al composite pipe without anneal.

5. The method of claim 1, wherein said planetary rolling machine has 3-6 rollers.

6. The method of claim 1, further comprising forming said Cu/Al composite pipe blank by a process of continuous casting.

7. The method claim 1, wherein said Cu/Al composite pipe blank is obtained by a surface treatment for combinative surfaces of a Cu pipe blank and a Al pipe blank, and then by a physical bonding treatment.

8. The method of claim 1, wherein said Cu/Al composite pipe blank is obtained by the surface treatment for combinative surfaces of the Cu pipe blank and the Al pipe blank, and then by a pipe expanding treatment.

9. The method of claim 1, wherein said Cu/Al composite pipe blank includes an inner pipe blank composed of Cu or a Cu alloy and an outer pipe blank composed of Al or an Al alloy.

10. A Cu/Al composite pipe manufactured by the method of claim 1, wherein said Cu/Al composite pipe has an inner layer composed of Cu, an outer layer composed of Al, and a combinative layer containing Cu and Al between said inner and outer layers, said combinative layer achieving a metallurgical bonding of said inner and outer layers.

11. The Cu/Al composite pipe of claim 10, wherein a thickness ratio of said inner layer to said outer layer is within a range of 1:0.4 to 1:20.

12. The Cu/Al composite pipe of claim 10, wherein said combinative layer has a thickness ranging from 1 μm to 3 μm.

13. The Cu/Al composite pipe of claim 10, further comprising an anticorrosion layer on an outer surface of said outer layer.

14. The Cu/Al composite pipe of claim 10, wherein said inner layer includes Cu in a Cu alloy form, and said inner layer includes Al in an Al alloy form.

15. The Cu/Al composite pipe of claim 10, wherein said Cu/Al composite pipe is adapted to be used in air-conditioners, refrigerators, solar energy, water heaters, condensers and radiators.

16. The method of claim 2, further comprising placing said Cu/Al composite pipe under a protective atmosphere when cooling.

17. The method of claim 16 further comprising placing said Cu/Al composite pipe under a protective atmosphere when rolling.

18 The method of claim 2, further comprising after rolling and cooling, directly drawing said Cu/Al composite pipe without anneal.

19. The method of claim 2, further comprising after rolling and cooling, processing said Cu/Al composite pipe with high speed spinning to add an internal thread.

20. The method of claim 1, further comprising after rolling, directly drawing said Cu/Al composite pipe without anneal.

21. The method of claim 1, further comprising after rolling, processing said Cu/Al composite pipe with high speed spinning to add an internal thread.

22. A Cu/Al composite pipe comprising:
an inner layer composed of Cu;
an outer layer composed of Al; and
a combinative layer containing Cu and Al, said combinative layer being between said inner and outer layers, said inner and outer layers being metallurgically bonded by said combinative layer.

23. The Cu/Al composite pipe of claim 22, wherein a thickness ratio of said inner layer to said outer layer is within a range of 1:0.4 to 1:20.

24. The Cu/Al composite pipe of claim 22, wherein said combinative layer has a thickness ranging from 1 μm to 3 μm.

25. The Cu/Al composite pipe of claim 22, further comprising an anticorrosion layer on an outer surface of said outer layer.

26. The Cu/Al composite pipe of claim 22, wherein said inner layer includes Cu in a Cu alloy form and said outer layer include Al in an Al alloy form.
